(19) United States
(12) Patent Application Publication
(10) Pub. No.: US 2010/0138517 A1
(43) Pub. Date: Jun. 3, 2010

(54) SYSTEM AND METHOD FOR MULTIMEDIA CONTENT BROKERING

(75) Inventors: Gustavo DE LOS REYES, Fair Haven, NJ (US); Cristina SERBAN, Middletown, NJ (US)

Correspondence Address: AT & T LEGAL DEPARTMENT - NDQ, ATTN: PATENT DOCKETING, ONE AT & T WAY, ROOM 2A-207, BEDMINSTER, NJ, 07921, US

(73) Assignee: AT&T Intellectual Property I, L.P., Reno, NV (US)

(21) Appl. No.: 12/326,328

(22) Filed: Dec. 2, 2008

(51) Int. Cl. G06F 15/16; G06Q 40/00

(52) U.S. Cl. 709/218; 705/35

(57) ABSTRACT

Disclosed herein are systems, computer-implemented methods, and tangible computer-readable media for brokering online multimedia content. The method includes receiving an online request (such as a search) for multimedia content from a user, retrieving a user profile associated with the user, locating a plurality of online multimedia providers having multimedia content satisfying the request, identifying a preferred provider from the plurality of online multimedia providers, determining information required by the preferred provider for access to the multimedia content satisfying the request, transmitting the required information from the user profile to the preferred provider in order to access the multimedia content satisfying the request, and instructing the preferred provider to transmit the multimedia content to a playback device of the user. The method can further include receiving a payment from the user for the multimedia content, and paying the fee charged by the preferred provider.

### BACKGROUND OF THE INVENTION

1. Field of the Invention

The present invention relates to online multimedia content delivery and more specifically to brokering with multimedia providers.

2. Introduction

The Internet allows users to access almost any multimedia content possible. However, when users desire to obtain multimedia content from the Internet, they must first determine where that content is offered. Then the provider typically requires users to establish an account (including setting up an account ID and password, defining payment methods, and so forth). Users already maintain too many username and password combinations and may not wish to create any more. Some providers require a special software multimedia client specific to the user device and the multimedia service provider. These software clients may not be available on the user's computing platform. Finally, after all these steps, the user can obtain the desired multimedia content and view it or listen to it. The user typically follows the same general flow, albeit with a different interface, options, questions, and order, for each provider who has content the user desires. This rather complex set of interactions between users and the numerous multimedia service providers significantly decreases ease-of-use. Further compounding the problem, many providers protect their content with Digital Rights Management (DRM). DRM can add restrictions such as whether content can be shared or copied, how long the user can view it, or how many times a user can view the content. Accordingly, what is needed in the art is an improved way for users to obtain multimedia content online.

### SUMMARY

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Disclosed are systems, computer-implemented methods, and tangible computer-readable media for brokering online multimedia content. The method includes receiving an online request (such as a search) for multimedia content from a user, retrieving a user profile associated with the user, locating a plurality of online multimedia providers having multimedia content satisfying the request, identifying a preferred provider from the plurality of online multimedia providers, determining information required by the preferred provider for access to the multimedia content satisfying the request, transmitting the required information from the user profile to the preferred provider in order to access the multimedia content satisfying the request, and instructing the preferred provider to transmit the multimedia content to a playback device of the user. The method can further include receiving a payment from the user for the multimedia content, and paying the fee charged by the preferred provider. Instructing the preferred provider to transmit the multimedia content to the user can further include instructing the preferred provider to transmit multimedia playback related resources to the playback device. If the multimedia content is episodic, the method can further subscribe to future episodic multimedia content for the user.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only exemplary embodiments of the invention and are not therefore to be considered to be limiting of its scope, the invention will be described and explained with additional specificity and detail through the use of the accompanying drawings in which:

FIG. 1 illustrates an example system embodiment;

FIG. 2 illustrates an example method embodiment;

FIG. 3 illustrates a prior art approach to interactions between an end user and multimedia service providers;

FIG. 4 illustrates a broker approach to interactions between an end user and multimedia service providers; and

FIG. 5 illustrates a sample user interface with a multimedia broker.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

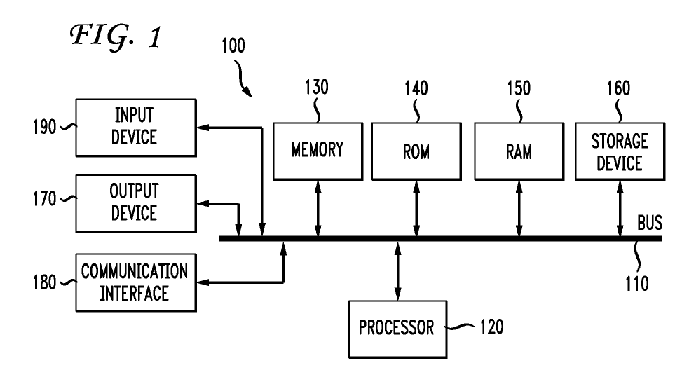

With reference to FIG. 1, an exemplary system includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. A processing unit 120 can include a general purpose CPU controlled by software as well as a special-purpose processor. An Intel Xeon LV L7345 processor is an example of a general purpose CPU which is controlled by software. Particular functionality may also be built into the design of a separate computer chip. An STMicroelectronics STA013 processor is an example of a special-purpose processor which decodes MP3 audio files. Of course, a processing unit includes any general purpose CPU and a module configured to control the CPU as well as a special-purpose processor where software is effectively incorporated into the actual processor design. A processing unit may essentially be a completely self-contained computing system, containing multiple cores or CPUs, a bus, memory controller, cache, etc. A multi-core processing unit may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. In one aspect, a hardware module that performs a particular function includes the software component stored in a tangible computer-readable medium in connection with the necessary hardware components, such as the CPU, bus, display, and so forth, to carry out the function. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The input may be used by the presenter to indicate the beginning of a speech search query. The device output 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software and hardware, such as a processor, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

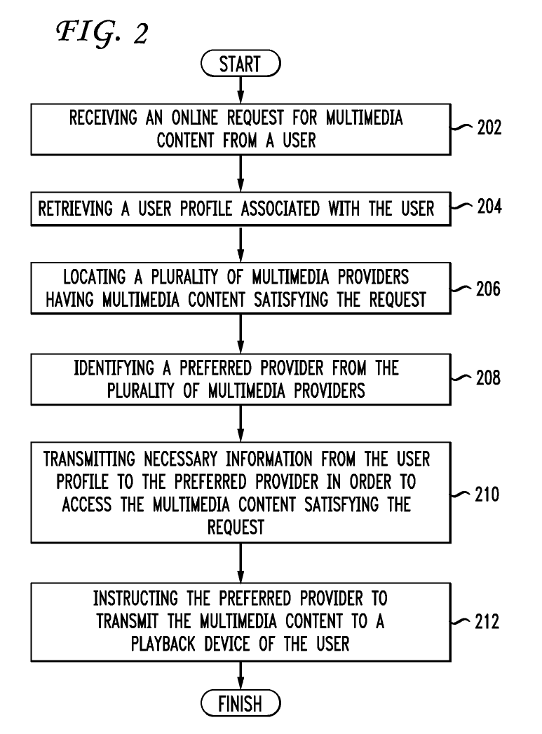

Having disclosed some fundamental system components, the disclosure turns to the exemplary method embodiment for brokering online multimedia content as illustrated in FIG. 2. For clarity, the method is discussed in terms of a system configured to practice the method. As a general matter, the disclosure covers a brokerage system which allows users to search for media in one place. In the case of searching for video, users must search multiple media sources, such as YouTube, Metacafe, Google Video, Dailymotion, iFilm, and others before finding the desired video. The principles disclosed herein allow for a user to search in one location which then searches on behalf of the user and brokers the details of acquiring or transmitting the video to the user. The system receives an online request for multimedia content from a user (202). The request can be in the form of a search. In one embodiment, the system interfaces with users via a web site. In another embodiment, the system employs a specialized software client running on a personal computer or a mobile device. The request can be a specific name of a piece of media, a category, key word, piece of metadata, author, actors, or virtually any other available descriptor. Multimedia content includes but is not limited to books, sound effects, music, video, images, and combinations.

The system retrieves a user profile associated with the user (204). The user profile can include preferences regarding price, payment methods, download speed, provider rankings, digital rights management (DRM), and multimedia format. For example, a user can establish a setting restricting results to free media content. A user can desire the highest resolution or most recent version of a video. The user profile can indicate that certain content providers or categories of content are off limits (similar to a parental filter). The user profile can be linked to user profiles at one or more online multimedia providers. For example, when the user signs up with the broker, she can link her broker account with her account on YouTube, her account on iFilm, and so forth. When the broker system searches YouTube, it searches using her YouTube account and previously established preferences.

The system locates a plurality of online multimedia providers having multimedia content satisfying the request (206). The system can actively query each multimedia provider when it receives the search. In another aspect, the system indexes content available at each multimedia providers and uses the index to determine which providers have the desired multimedia content. The system can update the multimedia index based on requests and aggregated trends in a group of requests.

The system identifies a preferred provider from the plurality of online multimedia providers (208). In one aspect, the system presents to the user a list of multimedia providers having multimedia content satisfying the request and identifies the preferred provider based on a user response to the list of multimedia providers. The system can present the list of providers on a screen, audibly, or by some combination of audio-visual output and other sensorial output. Perhaps the simplest embodiment is to display a list on a screen and allow the user to click on one of them. In cases where the multimedia content is episodic, such as television shows, podcasts, or audio/video blogs, the system can subscribe to future episodic multimedia content for the user. In that case, the broker system can determine at what interval the provider makes episodic content available, and automatically instruct the preferred provider to transmit the episodic content to the playback device of the user. Alternately, the broker system can notify the user that new episodic content is available.

The system determines information required by the preferred provider for access to the multimedia content satisfying the request (208). The system transmits the required information from the user profile to the preferred provider in order to access the multimedia content satisfying the request (210). For example, if the preferred provider is YouTube, certain videos flagged by users as inappropriate may require age verification. The system determines that the video requires additional information and effectively forwards to the provider any required additional information extracted from the user's account with the broker. If the user's account with the broker does not include that information, the system can prompt the user to enter the missing information. The system can then include that information in the user's profile and forward it to the provider in order to access the multimedia content.

The system instructs the preferred provider to transmit the multimedia content to a playback device of the user (212). The system can further instruct the preferred provider to transmit multimedia playback related resources to the playback device, such as a required media player or codec. The preferred provider can transmit the multimedia content directly to the user's playback device. The preferred provider can transmit the multimedia content to the broker system which then forwards the multimedia content to the user's playback device. The system can determine which path to instruct the preferred provider to take based on network traffic, available bandwidth, latency, and/or other considerations. The broker system can also adapt the multimedia content to the user's playback device or instruct the preferred provider to adapt the media. Some examples of adapting the multimedia include transcoding, changing resolution, deleting sections of the video, cropping the video, and other actions known to one of skill in the art. The user can then view the desired multimedia content. The system or the provider can stream or upload content to the user's playback device. The provider may impose restrictions or limitations on multimedia content usage.

In one aspect, where the preferred provider charges a fee to access the multimedia content, the system further receives a payment from the user for the multimedia content and pays the fee charged by the preferred provider. For example, the user can enter credit card information as part of a broker system user profile. When the user desires multimedia content from a provider who charges a fee, the broker system can pay the fee using the credit card information in the user profile. The broker can also pay an aggregated periodic fee to the provider based on all transactions in the period. The broker can withdraw the funds from the user's credit card and pay the provider with a broker credit card to insulate the user's credit card from the multimedia provider. In one embodiment, the broker system retains a portion of the fee.

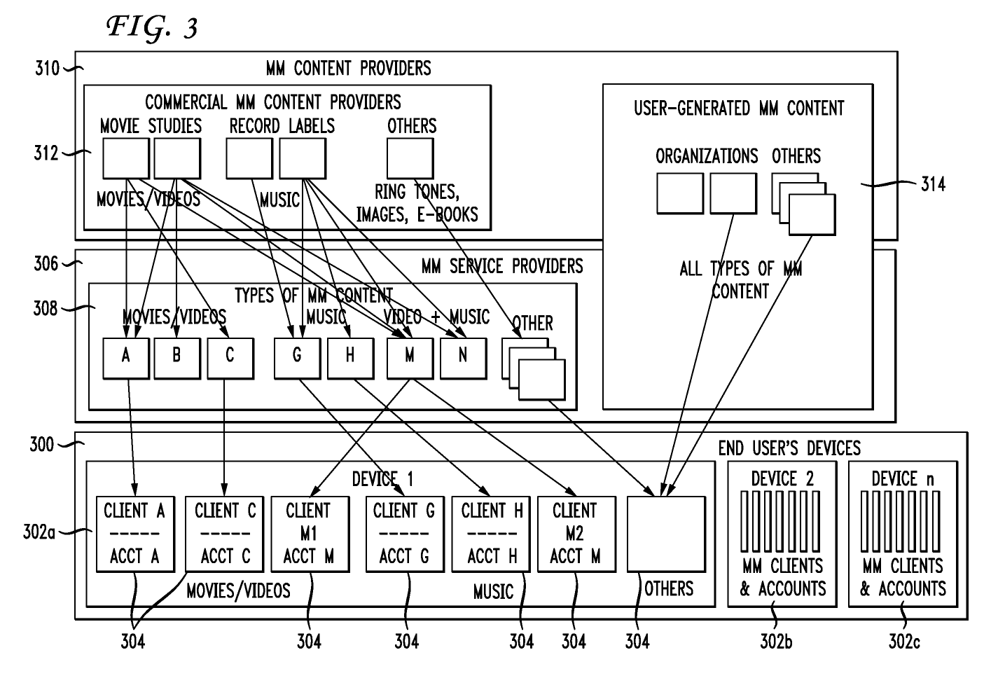

FIG. 3 illustrates a prior art approach to interactions between an end user and multimedia service providers. In the prior art, a user accesses a network, such as the Internet, through one or more end user device 300, such as a personal computer 302a, a set-top box 302b connected to a television, and a smart phone or personal digital assistant (PDA) 302c. In order to search for media, users create accounts 304 with numerous multimedia providers 306. Each multimedia service provider 306 offers different types of multimedia content 308 from different content providers 310. One type of content provider is commercial provider 312, such as Universal, Disney, Warner Music Group, and Paramount. Commercial providers 312 often offer their media through one or more multimedia service providers 306 in addition to their own official outlets. Another type of content provider is user-generated multimedia content 314 provided by people such as solo artists, YouTube users who upload home-made videos, and Flickr users who upload photographs. The user (or the user's device) must remember login information for each account to log in and access multimedia content from all these different sources. Further, a unified search for all the multimedia providers does not exist.

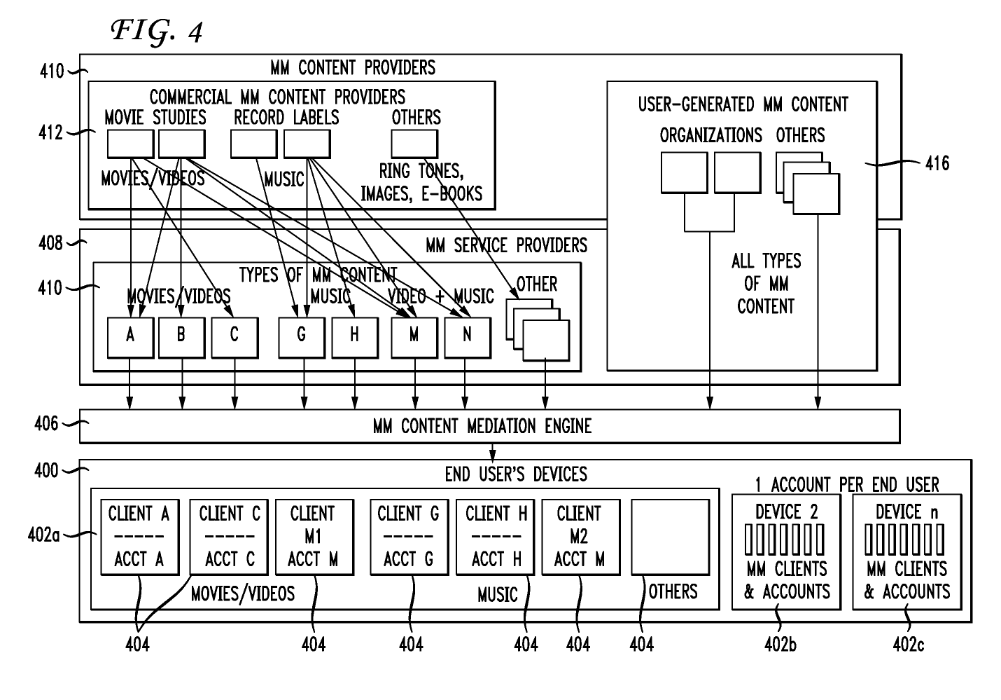

FIG. 4 illustrates a broker approach to simplify interactions between an end user and multimedia service providers. In this approach, a user accesses a network, such as the Internet, through one or more end user device 400, such as a personal computer 402a, a set-top box 402b connected to a television, and a smart phone or personal digital assistant (PDA) 402c. Rather than creating accounts 404 with numerous multimedia providers, users create a single account or profile with a multimedia content mediation engine 406. The multimedia content engine 406, or multimedia broker, can interface with different multimedia service providers 408 to allow the user to access different types of multimedia content 410 from different content providers 412. The multimedia broker 406 can even bypass multimedia service providers 408 and access multimedia content providers 412 directly. As discussed above, commercial providers 414 and individual content providers 416 generate multimedia content. Under this model, a user logs in to a single location, such as a website or a network-enabled software client, using a device 402a to search for and acquire multimedia content through the broker 406. The broker 406 queries each available service provider 408 and/or content provider 412 for matching multimedia content. In one aspect, user preferences or search terms limit the queried service providers. For example, if the user searches for “do it yourself plumbing video” and specifies free content only, then the broker skips audio-only providers and skips those results with an associated cost. If a certain provider requires a username and password to access content, the broker 406 can either create a new account with the provider linked to the user's broker account or link to a pre-existing account with the provider.

The broker 406 presents a list of matching media to the user. The list can include a summary of each match, including multimedia information, a thumbnail, resolution, duration, source of the matching multimedia content, etc. The user selects a desired result from the list of matching media, and the system instructs the preferred provider to transmit the appropriate media to the user's device. The preferred provider can directly transmit to the user's device or through the system to the user's device. The system and/or the preferred provider can include downloading, streaming, and even transcoding to different formats for different playback devices. User preferences can govern the ordering and the results of the list of matching media. For example, one user indicates a preference for the highest quality content regardless of price, while another user indicates a preference for the lowest cost content, even if it is low resolution or poor audio quality. These and other preferences can be user specific and/or search specific.

Rather than searching each multimedia provider for each query, the broker can maintain a database of each provider's contents which is updated periodically. When users search for multimedia content, the broker can compile information from a local database for each provider. In this way the broker does not depend on favorable network traffic conditions between the providers and the broker to provide results to the user promptly.

Providers may require that the broker show the user an End-User License Agreement (or similar terms of service agreement) associated with the multimedia content. Provisioned multimedia content can be digital rights management (DRM) free or can be protected. One example of free content is movie trailers available from www.apple.com/trailers. An example of media subject to DRM is an online movie rental which allows unlimited playback for 24 hours, after which the media expires and is not playable. When multimedia content is free, the broker does not need to handle payment. However when providers charge for multimedia content, the broker can unify the payment process for a user as well. The broker can accept payments from a user and forward all or part of those payments to the respective providers. For example, the broker can keep a portion of the payment as a finder's fee. When a broker conducts many transactions with a single provider, the broker can aggregate received payments and make a lump sum payment rather than a series of small payments. One advantage of this approach for payment is that users do not need to enter (and update) their credit or debit card information with a whole host of multimedia providers. Another advantage of this approach is that users pay providers indirectly through the broker, allowing for a somewhat greater level of security.

One advantage of this approach is that users can search for multimedia content in one place, with one account, on many devices. The principles disclosed herein can be altered to allow a user to provision multimedia content to a device other than the requesting device. For example, a user searches for “Star Trek: The Motion Picture” on her smart phone through the broker on her lunch break downtown and sees a 48 hour digital movie rental available for $1.99. She can rent the movie and indicate to the broker to provision “Star Trek: The Motion Picture” to her set-top box at home so it is ready for her to watch. The broker handles the details of payment and provisioning in a way that is transparent to both the user and the provider.

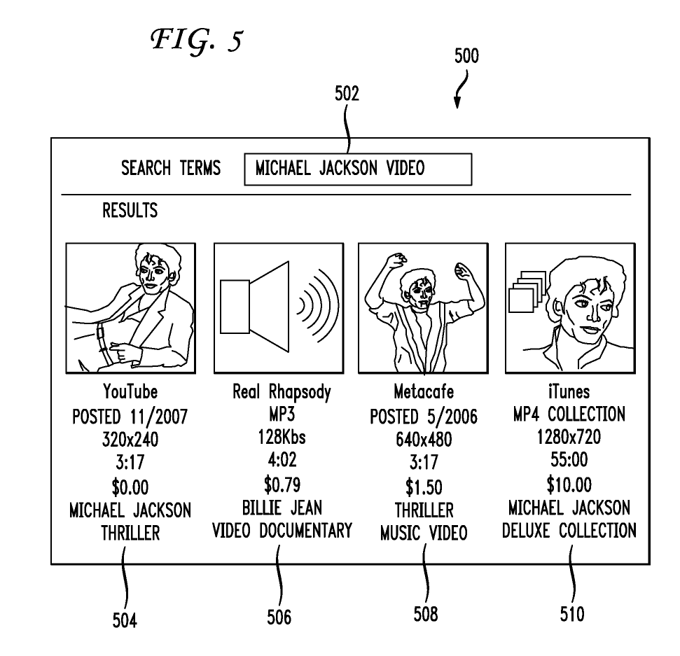

FIG. 5 illustrates a sample user interface with a multimedia broker. The interface 500 shows results from a query 502 for “Michael Jackson Video”. The broker in this case has already searched various providers, filtered the results based on the search terms and on user profile information. This interface 500 shows a detailed view of each multimedia result. For example, the system shows duration, price, provider, and title for each result 504, 506, 508, 510. Other details are not important, relevant, or available for some results. For instance, some results 504, 508, 510 include resolution and a thumbnail, but not others 506. User preferences with the broker can guide the level and type of details provided. If a result is subject to DRM, the details for that result can include applicable terms and restrictions.

Embodiments within the scope of the present invention may also include computer-readable media for carrying or having computer-executable instructions or data structures stored thereon. Such computer-readable media can be any available media that can be accessed by a general purpose or special purpose computer, including the functional design of any special purpose processor as discussed above. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, data structures, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the invention. For example, the principles herein may be applied to an existing online multimedia store to provide results from other providers alongside their own, similar to how Progressive Insurance offers their own insurance rates alongside competitors' rates. Those skilled in the art will readily recognize various modifications and changes that may be made to the present invention without following the example embodiments and applications illustrated and described herein, and without departing from the true spirit and scope of the present invention.

We claim:

1. A computer-implemented method of brokering online multimedia content, the method comprising:
receiving an online request for multimedia content from a user;
retrieving a user profile associated with the user;
locating a plurality of online multimedia providers having multimedia content satisfying the request;
identifying a preferred provider from the plurality of online multimedia providers;
determining information required by the preferred provider for access to the multimedia content satisfying the request;
transmitting the required information from the user profile to the preferred provider in order to access the multimedia content satisfying the request; and
instructing the preferred provider to transmit the multimedia content to a playback device of the user.

2. The computer-implemented method of claim 1, the method further comprising:
receiving a payment from the user for the multimedia content; and
paying a fee charged by the preferred provider.

3. The computer-implemented method of claim 1, wherein instructing the preferred provider to transmit the multimedia content to the user further comprises instructing the preferred provider to transmit multimedia playback related resources to the playback device.

4. The computer-implemented method of claim 1, wherein the user profile comprises one or more preferences regarding price, payment methods, download speed, provider rankings, digital rights management (DRM), multimedia format, and possible viewing devices.

5. The computer-implemented method of claim 1, the method further comprising:
presenting to the user a list of multimedia providers having multimedia content satisfying the request; and
identifying the preferred provider based on a user response to the list of multimedia providers.

6. The computer-implemented method of claim 5, wherein the multimedia content is episodic, the method further comprising subscribing to future episodic multimedia content for the user.

7. The computer-implemented method of claim 1, wherein the request is a search.

8. A system for brokering online multimedia content, the system comprising:
a module configured to receive an online request for multimedia content from a user;
a module configured to retrieve a user profile associated with the user;
a module configured to locate a plurality of online multimedia providers having multimedia content satisfying the request;
a module configured to identify a preferred provider from the plurality of online multimedia providers;
a module configured to determine information required by the preferred provider for access to the multimedia content satisfying the request;
a module configured to transmit the required information from the user profile to the preferred provider in order to access the multimedia content satisfying the request; and
a module configured to instruct the preferred provider to transmit the multimedia content to a playback device of the user.

9. The system of claim 8, the system further comprising:
a module configured to receive a payment from the user for the multimedia content; and
a module configured to pay a fee charged by the preferred provider.

10. The system of claim 8, wherein the module configured to instruct the preferred provider to transmit the multimedia content to the user further instructs the preferred provider to transmit multimedia playback related resources to the playback device.

11. The system of claim 8, wherein the user profile comprises one or more preferences regarding price, payment methods, download speed, provider rankings, digital rights management (DRM), multimedia format, and possible viewing devices.

12. The system of claim 8, the system further comprising:
a module configured to present to the user a list of multimedia providers having multimedia content satisfying the request; and
a module configured to identify the preferred provider based on a user response to the list of multimedia providers.

13. The system of claim 12, wherein the multimedia content is episodic, the system further comprising a module configured to subscribe to future episodic multimedia content for the user.

14. The system of claim 8, wherein the request is a search.

15. A tangible computer-readable medium storing a computer program having instructions for brokering online multimedia content, the instructions comprising:
receiving an online request for multimedia content from a user;
retrieving a user profile associated with the user;
locating a plurality of online multimedia providers having multimedia content satisfying the request;
identifying a preferred provider from the plurality of online multimedia providers;
determining information required by the preferred provider for access to the multimedia content satisfying the request;
transmitting the required information from the user profile to the preferred provider in order to access the multimedia content satisfying the request; and
instructing the preferred provider to transmit the multimedia content to a playback device of the user.

16. The tangible computer-readable medium of claim 15, the instructions further comprising:
receiving a payment from the user for the multimedia content; and
paying a fee charged by the preferred provider.

17. The tangible computer-readable medium of claim 15, wherein instructing the preferred provider to transmit the multimedia content to the user further comprises instructing the preferred provider to transmit multimedia playback related resources to the playback device.

18. The tangible computer-readable medium of claim 15, wherein the user profile comprises one or more preferences regarding price, payment methods, download speed, provider rankings, digital rights management (DRM), multimedia format, and possible viewing devices.

19. The tangible computer-readable medium of claim 15, the instructions further comprising:
presenting to the user a list of multimedia providers having multimedia content satisfying the request; and
identifying the preferred provider based on a user response to the list of multimedia providers.

20. The tangible computer-readable medium of claim 19, wherein the multimedia content is episodic, the instructions further comprising subscribing to future episodic multimedia content for the user.
